(19) United States
(12) Patent Application Publication
(10) Pub. No.: US 2003/0192240 A1
(43) Pub. Date: Oct. 16, 2003

(54) Method of wrapping a pot with a hexagonal floral sleeve

(76) Inventor: Donald E. Weder, Highland, IL (US)

Correspondence Address: Attn: Christopher W. Corbett, Dunlap, Codding & Rogers, P.C., Suite 420, 9400 North Broadway, Oklahoma City, OK, 73114, US

(21) Appl. No.: 10/124,812

(22) Filed: Apr. 12, 2002

(51) Int. Cl. A01G 9/02

(52) U.S. Cl. 47/72

(57) ABSTRACT

A floral sleeve sized to contain a flower pot, and method of use thereof, the sleeve generally having a hexagonal shape and which can be connected via a securing element to a pot disposed within the sleeve. The sleeve may have a detachable upper portion for supporting the sleeve from a support device or for enclosing a floral grouping disposed within the pot.

### CROSS REFERENCE TO RELATED APPLICATIONS

NOT APPLICABLE

### FIELD OF THE INVENTION

This invention generally relates to sleeves, and more particularly, sleeves used to contain floral groupings with or without growing or retaining media, or used to wrap flower pots with or without floral groupings and/or media and methods of using same.

### BRIEF DESCRIPTION OF THE DRAWINGS

FIG. 1 is an elevational view of a sleeve constructed in accordance with the present invention.

FIG. 2 is a cross-sectional view of the sleeve of FIG. 1 taken along line 2-2.

FIG. 3 is a cross-sectional view of the sleeve of FIG. 1 taken along line 3-3.

FIG. 4 is a cross-sectional view of the sleeve of FIG. 1 taken along line 4-4.

FIG. 5 is an elevational view of a flower pot.

FIG. 6 is a cross-sectional view of the flower pot of FIG. 5 taken along line 6-6.

FIG. 7 is a perspective view of the sleeve of FIG. 1 secured about the flower pot of FIG. 5 via a securing element.

FIG. 8 is another perspective view of the sleeve of FIG. 1 secured about the flower pot of FIG. 5 with the securing element positioned above an upper end of the flower pot.

FIG. 9 is an elevational view of another sleeve constructed in accordance with the present invention.

FIG. 10 is a cross-sectional view of the sleeve of FIG. 9 taken along line 10-10.

FIG. 11 is an elevational view of another sleeve constructed in accordance with the present invention.

FIG. 12 is a cross-sectional view of the sleeve of FIG. 11 taken along line 12-12.

FIG. 13 is an elevational view of another sleeve constructed in accordance with the present invention.

FIG. 14 is a cross-sectional view of the sleeve of FIG. 13 taken along line 14-14.

FIG. 15 is an elevational view of another sleeve constructed in accordance with the present invention.

FIG. 16 is a cross-sectional view of the sleeve of FIG. 15 taken along line 16-16.

### DESCRIPTION OF THE PREFERRED EMBODIMENTS

The floral sleeves described and claimed herein have a number of advantages over preformed pot covers and sheets of material presently used in the floral industry to decorate and cover flower pots.

The floral sleeves contemplated herein generally are constructed of less material than many preformed pot covers, for example those covers known in the art as Speed Covers®. Constructed as they are in a flattened condition, they occupy less warehouse space. They are produced in a manner that allow them to be printed more economically and with a higher degree of quality and using a variety of printing techniques thereby achieving a wide variety of decorative effects. These sleeves reduce freight costs in comparison to covers having a three-dimensional or opened configuration. Sleeves such as claimed herein cost less to produce since their production is more highly automated. Less material is required to construct a flat floral sleeve than a Speed Covers® or other types of covers like injection-molded covers, sheets wrapped and banded about pots, or separate sleeves and covers used together. When used in conjunction with a “banding apparatus”, the sleeves contemplated herein lend themselves to being bandingly secured about pots more easily and efficiently than flat, non-tubular, sheets of material. Labor costs in the application of the presently claimed sleeves are reduced compared to most other types of covers since the pot covering portion and plant covering portion, where claimed herein, are applied simultaneously rather than in separate steps.

Also, the present sleeves automatically “center” themselves on the pot, unlike a flat sheet of material. This improves the efficiency of attaching the sleeve to the pot via an adhesive or cohesive material, or banding element, because correct placement of the cover is achieved more readily. Further, the application of labels to a sleeve is facilitated and more easily automated and is less costly than with many other types of covers. Further, production cost of making sleeves is reduced because tooling costs per unit are reduced, since it's easier to change from making one size of sleeves to another compared to changing the tooling for different sizes of Speed Covers®.

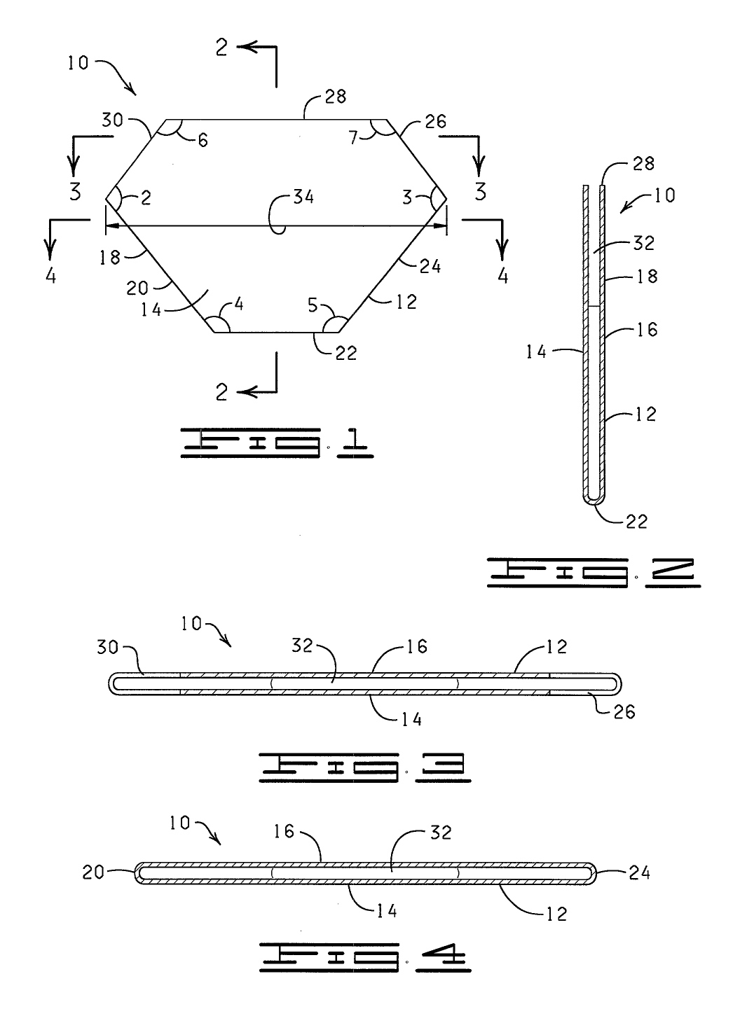

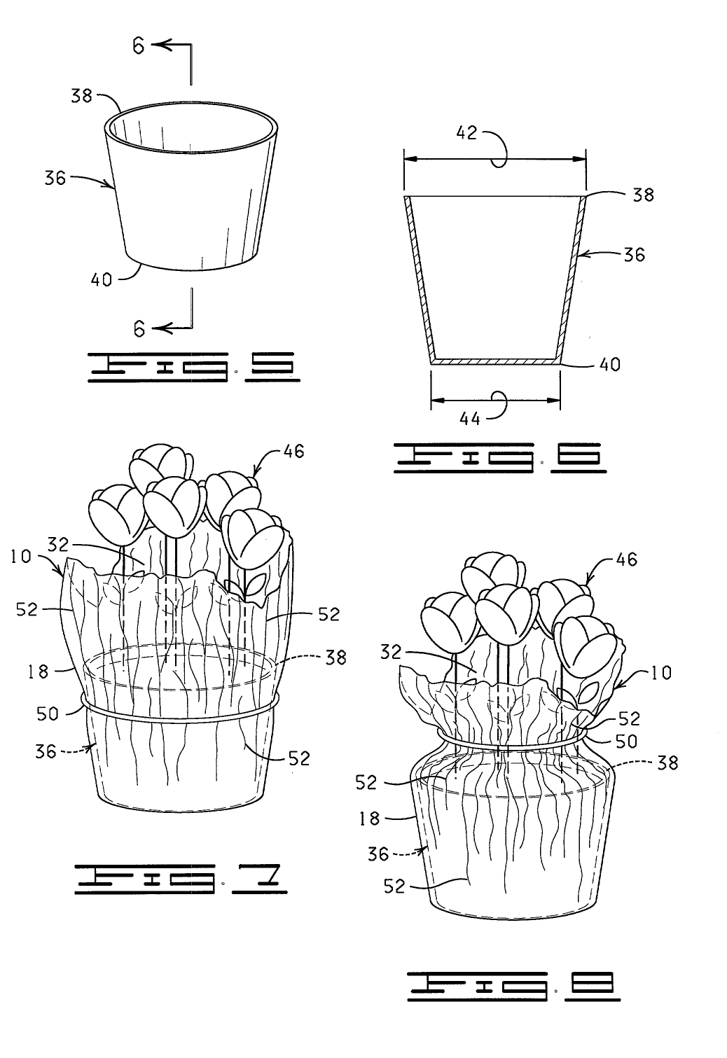

Turning now to the drawings, shown in FIGS. 1-4, and designated therein by the general reference numeral 10 is a flexible, preformed tubular floral sleeve (also referred to herein simply as a “sleeve”) having a hexagonal shape when in a flattened condition. The sleeve 10 can be opened from the flattened condition to an opened condition for receiving a pot, a flower pot, a floral grouping (alone or with a growing, ballast or retaining medium), or a pot with a botanical item disposed therein.

Sleeve 10 (FIGS. 1-4) comprises a body 12 having a hexagonal shape and having a front panel 14 and a back panel 16 which together comprise a sidewall 18 of the body 12. The body 12 comprises a hexagon having six sides, including a lower left side 20, a bottom side 22, a lower right side 24, an upper right side 26, a top side 28 and an upper left side 30. When the body 12 is opened from the flattened condition to an open condition, an interior space 32 sized to at least partially contain a pot 36 is exposed.

The body 12 has a maximum width 34 when in the flattened condition. The pot 36 (FIGS. 5 and 6) has an upper end 38 and a lower end 40. The pot 36 has a maximum diameter 42 which is usually near the upper end 38 and a minimum diameter 44 which is usually near the lower end 40.

The body 12 of sleeve 10 has six internal angles including angle 2 between upper left side 30 and lower left side 20, angle 3 between upper right side 26 and lower right side 24, angle 4 between lower left side 20 and bottom side 22, angle 5 between lower right side 24 and bottom side 22, angle 6 between upper left side 30 and top side 28, and angle 7 between upper right side 26 and top side 28. Each of angles 2, 3, 4, 5, 6 and 7 is less than 180°.

The maximum width 34 of the body 12 is generally the distance between angle 2 and angle 3. The lower left side 20, the bottom side 22 and the lower right side 24 are closed (sealed for example with a lap seal, a heat seal, a butt seal, a fin seal, or any other appropriate seal or connection in any conventional manner known by a person of ordinary skill in the art) as shown in FIG. 2. The upper left side 30, the top side 28 and the upper right side 26 are preferably open, that is, unsealed, as shown in FIGS. 2 and 3, so they can be more effectively spread out when the pot 36 is disposed within the interior space 32 of the body 12 thereby providing the sleeve 10 with the appearance of a decorative sheet of material formed about the pot 36. The open upper left side 30 and open upper right side 26 enable portions of the body 12 to be flared out and adjusted upwardly, downwardly, inwardly, or outwardly to taylor the decorative effect provided by the sleeve 10.

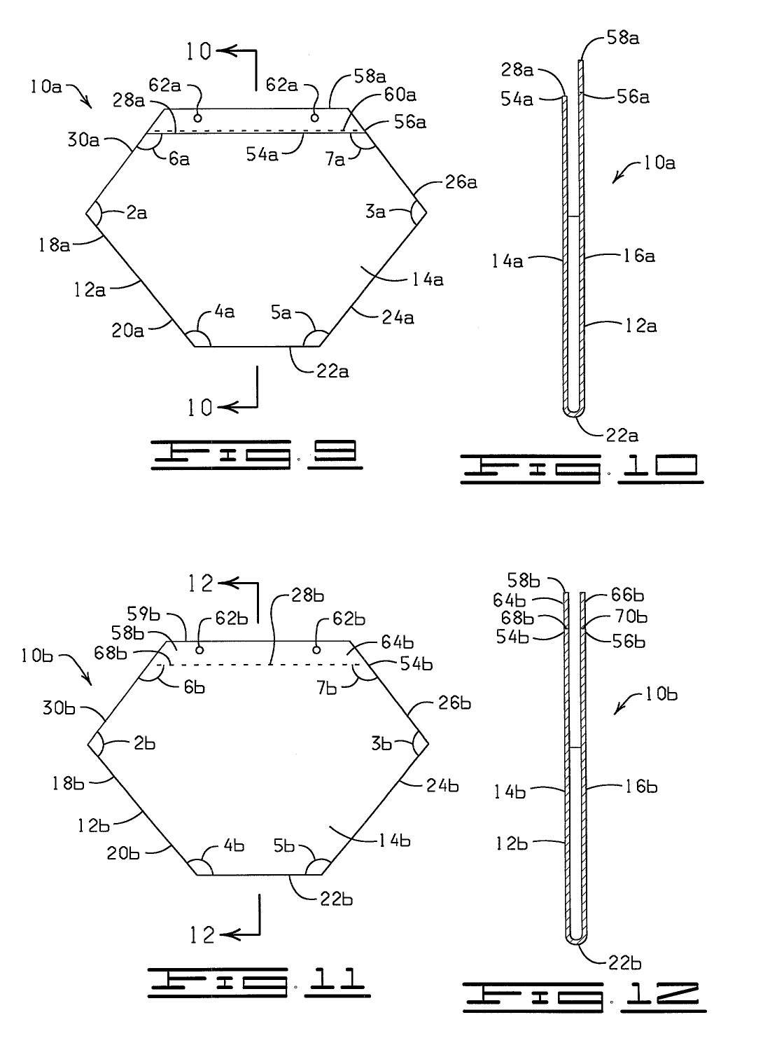

In a preferred version of the invention, the pot 36 having a floral grouping 46 disposed therein is disposed within the sleeve 10 as shown in FIGS. 7 and 8. Shown in FIG. 7 is the sleeve 10 and the pot 36 which has been disposed within the interior space 32. In a preferred version of the method of use of the sleeve 10 contemplated herein (or any other sleeve described elsewhere herein), when the pot 36 is placed within the sleeve 10, a securing element 50 is manually or automatically placed about the sleeve 10 and the pot 36 for securing the sleeve 10 about the pot 36 and for forming a decorative effect provided when overlapping folds 52 are formed in the sidewall 18 of the sleeve 10 the securing element 50 may be positioned below the upper end 38 of the pot 36 (FIG. 7) or above the upper end 38 of the pot 36 (FIG. 8). The securing element 50 may be, for example, an elastic band, a rubber band, a plastic strip, a string, a tie, a wire, a ribbon, a heat shrinkable material, a paper collar, a polymer strip, a stribbon, a tape, a label, or other device typically used in the art as a securing device.

The sleeve 10 comprises “excess material” wherein the interior space 32 is substantially larger than necessary to contain the pot 36. When the sleeve 10 is applied about the pot 36 and secured thereabout forming the overlapping folds 52, the sleeve 10 provides the decorative appearance of a flat sheet of material which has been formed about the pot 36 and tied about the pot 36 with a tie. The overlapping folds 52 are restrained in an overlapping condition by the securing element 50.

In a preferred embodiment, the sleeve 10 has approximate dimensions of: about 3.75 inches for the upper left side 30 and upper right side 26, about 8.25 inches for the lower left side 20 and lower right side 24, about 5.25 inches for the bottom side 22, about 14.5 inches for the top side and about 17 inches for the maximum width 34. A sleeve 10 having these dimensions is sized to contain a pot 36 having an approximate maximum diameter 42 of six inches and an approximate minimum diameter 44 of four inches (a pot known in the floral industry as a “6-inch” pot).

Equivalent sizes of sleeves can be readily manufactured using methods known by persons of ordinary skill in the art for other standard sizes of pots such as 4 inch, 4.5 inch, 5 inch, 5.5 inch, 6 inch, 6.5 inch, 7 inch, 7.5 inch, 8 inch, and other sizes well known in the art and commercially available. In particular, as noted above, it is desirable to have excess material in the sidewall 18 of the sleeve 10 such that when the pot 36 is disposed in the sleeve 10 and the sleeve 10 is secured about the pot 36 via the securing element 50, overlapping folds 52 are formed in the sidewall 18. In order to provide sufficient excess material in the sidewall 18, the maximum width 34 of the body 12 is preferably a factor of at least 2.1 times greater than the maximum diameter 42 of the pot 36. Alternatively, the factor may be 2.16, 2.5, 2.8, 3.0 or 3.2, for example. Further, the maximum width 34 of the body 12 is preferably a factor of at least 3.2 times greater than the minimum diameter of the pot 36. Alternatively, the factor may be 3.5, 3.75, 4.0, 4.25, 4.5 or 4.75, for example.

In general, when a flat sleeve has a maximum width 34 which is a factor of about 1.66 greater than the maximum diameter of a pot, and which is a factor of about 2.5 greater than the minimum diameter of a pot, such a sleeve will fit closely about that pot. Therefore, in general, the maximum width 34 of the body 12 described herein will have a factor greater than 1.66 when compared to the maximum diameter 42 of the pot 36 and will have a factor greater than 2.5 when compared to the minimum diameter 44 of the pot 36.

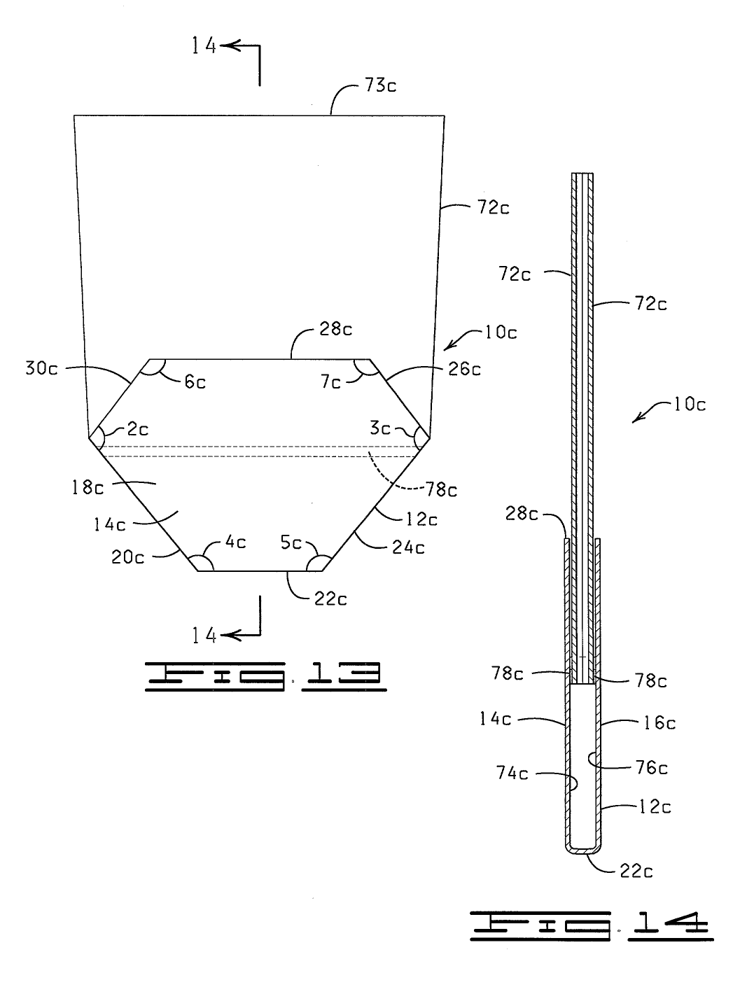

Shown in FIGS. 9 and 10 and referred to therein as floral sleeve 10a is a sleeve which is similar in all ways to sleeve 10 as described above, except as explained below. Sleeve 10a has a body 12a, a front panel 14a, a back panel 16a, a sidewall 18a comprising the front panel 14a and back panel 16a, a lower left side 20a, a bottom side 22a, a lower right side 24a, an upper right side 26a, a top side 28a, and an upper left side 30a.

Sleeve 10a differs from sleeve 10 in that it further comprises a support extension 58a which extends from a top end 56a of back panel 16a. Front panel 14a has a top end 54a. The support extension 58a is detachable via a detaching element 60a which is shown in FIG. 9 as comprising apertures 62a and a line of perforations but which may be in alternate embodiments, or tear strip, a zipper, or score line or weakened area, or any other device used as a detaching or tearing device. The support extension 58a serves to support the sleeve 10a from a support device such as a wicket, pin, hanger, staple, clip, adhesive or cohesive material, or other devices or means well known in the art for connecting or hanging sleeves together in a pad.

Generally, the support extension 58a is removed before the sleeve 10a is disposed about the pot 36 but may be removed after the sleeve 10a is disposed about the pot 36. The top side 28a comprises the top end 54a of the front panel 14a and the top end 56a of the back panel 16a (which is exposed as an edge when the support extension 58a is detached via the detaching element 60a).

The body 12a of sleeve 10a has six internal angles including angle 2a between upper left side 30a and lower left side 20a, angle 3a between upper right side 26a and lower right side 24a, angle 4a between lower left side 20a and bottom side 22a, angle 5a between lower right side 24a and bottom side 22a, angle 6a between upper left side 30a and top side 28a, and angle 7a between upper right side 26a and top side 28a. Each of angles 2a, 3a, 4a, 5a, 6a and 7a is less than 180°.

Shown in FIGS. 11 and 12 and referred to therein as floral sleeve 10b is a sleeve which is similar in all ways to sleeve 10 as described above except as explained below.

Sleeve 10b has a body 12b, a front panel 14b, a back panel 16b, a sidewall 18b, comprising the front panel 14b and back panel 16b, a lower left side 20b, a bottom side 22b, a lower right side 24b, an upper right side 26b, a top side 28b, and an upper left side 30b. Sleeve 10b differs from sleeve 10 in that it further comprises a support extension 58b which extends from the top side 28b which further comprises a front panel extension 64b which extends from a top end 54b of front panel 14b and a back panel extension 66b which extends from a top end 56b of back panel 16b. Support extension 58b has a top end 59b which may be open (unsealed) or closed (sealed). The support extension 58b preferably comprises apertures 62b adapted for use with a support device as described herein.

The support extension 58b is detachable via a front panel detaching element 68b for detaching the front panel extension 64b and a back panel detaching element 70b for detaching the back panel extension 66b, wherein the detaching elements 68b and 70b are like those defined elsewhere hereinabove. The support extension 58b serves to support the sleeve 10b from a support device such as a wicket, pin, hanger, staple, clip, adhesive or cohesive material, or other devices or means well known in the art for connecting or hanging sleeves together in a pad. As described above, the support extension 58b may be detached before or after the pot 36 is placed within the sleeve 10b.

The body 12b of sleeve 10b has six internal angles including angle 2b between upper left side 30b and lower left side 20b, angle 3b between upper right side 26b and lower right side 24b, angle 4b between lower left side 20b and bottom side 22b, angle 5b between lower right side 24b and bottom side 22b, angle 6b between upper left side 30b and top side 28b, and angle 7b between upper right side 26b and top side 28b. Each of angles 2b, 3b, 4b, 5b, 6b and 7b is less than 180°.

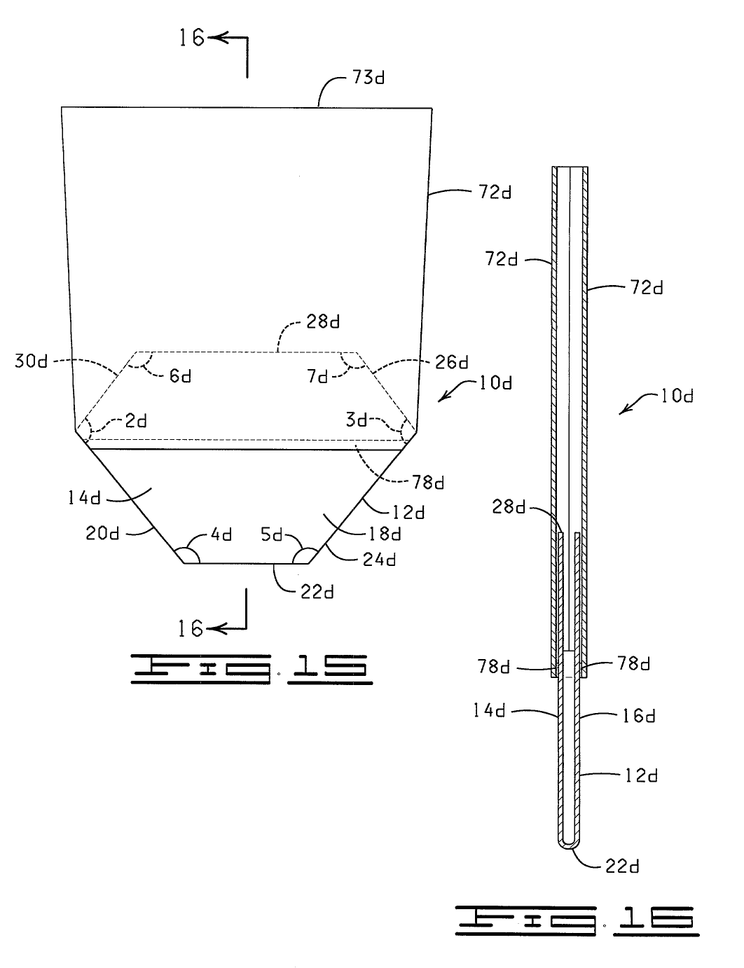

Shown in FIGS. 13 and 14 and referred to therein as floral sleeve 10c is a sleeve which is similar in all ways to sleeve 10 as described above, except as explained herein.

Sleeve 10c has a body 12c, a front panel 14c, a back panel 16c, a sidewall 18c, comprising the front panel 14c and back panel 16c, a lower left side 20c, a bottom side 22c, a lower right side 24c, an upper right side 26c, a top side 28c, and an upper left side 30c. Sleeve 10c differs from sleeve 10 in that it further comprises an upper portion 72c which extends beyond the topside 28c.

Upper portion 72c has an upper end 73c and is attached to a portion of an inner surface 74c of front panel 14c and to a portion of an inner surface 76c of back panel 16c at an attached area 78c. The upper portion 72c has a tubular shape for enclosing and surrounding all of, or a portion of, the floral grouping 46 when the pot 36 and floral grouping 46 or floral grouping 46 alone is disposed within the sleeve 10c. The upper portion 72c can be detached from the body 12c after the pot 36 and/or floral grouping 46 have been disposed within the body 12c. The upper portion 72c may be detached via a detaching element (not shown) in the sleeve 10c. The upper portion 72c may also comprise apertures (not shown) for supporting the sleeve 10c from a support device as described elsewhere herein. The sleeve 10c may be gathered and/or connected into a pad as described elsewhere herein.

The body 12c of sleeve 10c has six internal angles including angle 2c between upper left side 30c and lower left side 20c, angle 3c between upper right side 26c and lower right side 24c, angle 4c between lower left side 20c and bottom side 22c, angle 5c between lower right side 24c and bottom side 22c, angle 6c between upper left side 30c and top side 28c, and angle 7c between upper right side 26c and top side 28c. Each of angles 2c, 3c, 4c, 5c, 6c and 7c is less than 180°.

Shown in FIGS. 15 and 16 and referred to therein as floral sleeve 10d is a sleeve which is similar to sleeve 10c as described above, except as explained herein.

Sleeve 10d has a body 12d, a front panel 14d, a back panel 16d, a sidewall 18d comprising the front panel 14d and back panel 16d, a lower left side 20d, a bottom side 22d, a lower right side 24d, an upper right side 26d, a top side 28d, and an upper left side 30d. Sleeve 10d differs from sleeve 10c in that sleeve 10d comprises an upper portion 72d which is like upper portion 72c of sleeve 10c except upper portion 72d is attached to an outer surface 80d of front panel 14d and to an outer surface 82d of back panel 16d at an attached area 78d. Otherwise, sleeve 10d functions in a manner similar to sleeve 10c.

The body 12d of sleeve 10d has six internal angles including angle 2d between upper left side 30d and lower left side 20d, angle 3d between upper right side 26d and lower right side 24d, angle 4d between lower left side 20d and bottom side 22d, angle 5d between lower right side 24d and bottom side 22d, angle 6d between upper left side 30d and top side 28d, and angle 7d between upper right side 26d and top side 28d. Each of angles 2d, 3d, 4d, 5d, 6d and 7d is less than 180°.

Any of the sleeve 10-10d shown herein or variations thereof contemplated herein may be secured about the pot 36 in the manner shown in FIGS. 7 and 8.

As discussed elsewhere herein, a plurality of sleeves 10-10d may be stacked together to form a pad and which may be supported on a support assembly such as a wicket, hanger or on a belt worn by a floral worker, for example in a greenhouse or plant warehouse or packaging or shipping facility such as shown in Atty. Dkt. No. 8403.456, filed as a U.S. patent application on Apr. 9, 2002, having U.S. Express Mail Receipt No. EV010195862US, and which is expressly incorporated by reference herein in its entirety.

The securing element 50 may be, for example, a rubber or elastic band, a string, a ribbon, a collar, a wire, a band, a heat shrinkable strip, band or loop, an adhesive or cohesive, a label, or another banding device known to a person of ordinary skill in the art. The securing element 50 may be, in an alternative embodiment, preconnected to the sleeves 10-10d described herein before application of the sleeve about the pot 36 or it may be applied, either manually or automatically after the pot 36 has been disposed within the sleeve 10-10d.

The sleeves 10-10d are constructed from material which is flexible, semi-rigid, rigid, or any combination thereof. The sleeve 10-10d may be constructed of a single layer of material or a plurality of layers of the same or different types of materials. Any thickness of the material may be utilized as long as the material functions in accordance with the present invention and is expandable to an open position as described herein. The layers of material comprising the sleeves 10-10d may be connected together or laminated or may be separate layers. Such materials used to construct the sleeves 10-10d are described in U.S. Pat. No. 5,111,637, for example, which is hereby incorporated herein by reference. Any thickness of material may be utilized in accordance with the present invention as long as the sleeves 10-10d may be formed as described herein, and as long as the sleeves 10-10d may contain at least a portion of the pot 36 or potted plant or floral grouping 46, as described herein. Additionally, an insulating material such as bubble film, preferable as one of two or more layers, can be utilized in order to provide additional protection for the item, such as the floral grouping 46, contained therein.

Generally the material from which the sleeves 10-10d are constructed has a thickness in a range from about 0.1 mil to about 30 mils. Often, the thickness of the material used to construct the sleeves 10-10d ranges from about 0.5 mil to about 10 mils. Preferably, the-sleeves 10-10d have a thickness in a range from about 1.0 mil to about 5 mils.

In one embodiment, the sleeves 10-10d may be constructed from a sheet comprising two polypropylene films. The material comprising the sleeves 10-10d may be connected together or laminated or may be separate layers. In alternative embodiments, the sleeves 10-10d may be constructed from only one of the polypropylene films.

The sleeves 10-10d are constructed from any suitable material that is capable of being formed into sleeves 10-10d and wrapped about pot 36 and floral grouping 46 disposed therein. Preferably, the material comprises untreated or treated paper, metal foil, polymer film, non-polymer film, woven or nonwoven fabric, synthetic or natural fabric, cardboard, fiber, cloth, burlap, or laminations or combinations thereof.

The term “polymer film” means a man-made polymer such as a polypropylene or a naturally occurring polymer such as cellophane. A polymer film is relatively strong and not as subject to tearing (substantially non-tearable), as might be the case with paper or foil.

The material comprising the sleeves 10-10d may vary in color and may consist of designs or decorative patterns which are printed, etched, and/or embossed thereon using inks or other printing materials. An example of an ink which may be applied to the surface of the material is described in U.S. Pat. No. 5,147,706, and which is hereby expressly incorporated herein by reference in its entirety.

In addition, the material used to construct the sleeves 10-10d may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to the upper and/or lower surface of the material comprising the sleeves 10-10d. Moreover, portions of the material used in constructing the sleeve may vary in the combination of such characteristics. The material utilized for the sleeves 10-10d may be opaque, translucent, transparent, or partially clear or tinted transparent. Any portion of the sleeves 10-10d, or the entire sleeves 10-10d may have a design, pattern or decoration printed thereon.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping comprises a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule.”

The term “growing medium” when used herein means any liquid, solid or gaseous material used for plant growth or for the cultivation of propagules, including organic and inorganic materials such as soil, foam, humus, perlite, vermiculite, sand, beads, water, and including the nutrients, fertilizers or hormones or combinations thereof required by the plants or propagules for growth and also may merely be a “retaining” or “ballast” material which does not aid in growth but helps in supporting the sleeve 10-10d in an opened condition.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

The term “propagule” when used herein means any structure capable of being propagated or acting as an agent of reproduction including seeds, shoots, stems, runners, tubers, plants, leaves, roots or spores.

An adhesive or cohesive bonding material may be disposed on a portion of the sleeves 10-10d to assist in holding the sleeves 10-10d to the pot 36 therein when such the pot 36 is disposed within the sleeves 10-10d. A second bonding material (not shown) may be applied to an upper portion of the upper portions 72c and 72d near the upper ends 73c and 73d, respectively, for sealing the upper portion 72c-72d of the sleeve 10c-10d, after the pot 36 has been disposed therein.

Where present, the bonding materials may be disposed as a strip or block on a surface of the sleeves 10-10d. Further, the bonding materials may be disposed as spots, or in any other geometric, non-geometric, asymmetric, or fanciful form, and in any pattern including covering either the entire inner surfaces of the sleeves 10-10d. The bonding materials may be covered by a cover or release strip which can be removed prior to the use of the sleeves 10-10d. The bonding materials can be applied by means known to those of ordinary skill in their art.

The term “bonding material” when used herein means an adhesive, frequently a pressure sensitive adhesive, or a cohesive. When the bonding material is a cohesive, a similar cohesive material must be placed on the adjacent surface (e.g. on the outer surface of the pot) for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

Any of the sleeves 10-10d described herein may also be equipped with one or more drainage holes in or near a bottom side 22-22d, respectively, thereof or ventilation holes (not shown) or can be made from permeable or impermeable materials.

Preferably the sleeves 10-10d are sized to contain and conform to one of a variety of standard sizes of pots 36 known to those of ordinary skill in the art, such as described above. As noted above, the sleeves 10-10d may be used to contain a plant and a growing medium without the use of the pot 36.

The term “pot” as used herein refers to any type of container or vase used for holding a floral grouping or plant. Examples of pots, used in accordance with the present invention include, but not by way of limitation, clay pots, wooden pots, foam pots, plastic pots, pots made from natural and/or synthetic fibers, or any combination thereof. The pot is generally adapted to receive a floral grouping in the retaining space. The floral grouping may be disposed within the pot along with a suitable growing medium described in further detail below, or other retaining medium, such as a floral foam. It will also be understood that the floral grouping, and any appropriate growing medium or other retaining or ballast medium, may be disposed in the sleeves 10-10d without the pot 36 or other container.

The sleeves 10-10d described herein may be formed in a manner well known in the art by advancing two separate webs, one or two webs preformed in the form of a tube, or a single web folded double and sealing potions of the longitudinal sides and sealing the bottom side of the two facing panels then cutting the sleeve thus formed from the webs or web. Machines which can form sleeves from such single webs or pairs of webs are well within the knowledge of one of ordinary skill in the art.

It should be further noted that various other features of the versions of the present invention described herein such as closure bonding areas, support extensions, handles, additional perforations, drainage holes, ventilation holes, combinations of material may be used alone or in combination as elements of any of the embodiments described above herein.

The sleeves 10-10d may comprise a portion of a plant package as shown for example in FIGS. 7 and 8, which additionally comprises the pot 36 disposed within the sleeve 10-10d, the pot 36 may have the floral grouping 46 disposed therein wherein the pot assembly is substantially surrounded and encompassed by the sleeve 10-10d or a portion thereof. Alternatively, the plant package may comprise only the sleeve 10-10d, the floral grouping 46, and a retaining, ballast, or growing medium for supporting the floral grouping 46.

These embodiments described herein are not intended to limit the scope and extent of the claimed invention but are only intended to exemplify various embodiments of the invention contemplated herein.

Changes may be made in the construction and the operation of the various components, elements and assemblies described herein or in the steps or the sequence of steps of the methods described herein without departing from the spirit and scope of the invention as defined in the following claims.

What is claimed is:

1. A method of wrapping a pot having a floral grouping disposed therein, comprising:
providing a floral sleeve comprising a body having a sidewall comprising a front panel and a back panel, the body initially having a flattened condition and the body, when in the flattened condition, having a hexagonal shape comprising a lower left side, a bottom side, a lower right side, an upper right side, a top side, and an upper left side, and wherein the lower left side, the bottom side, and the lower right side are closed and the upper right side, the top side, and the upper left side are open, and the body having an interior space when opened to an opened condition, the interior space sized to at least partially contain a pot;
opening the floral sleeve to expose the interior space and disposing the pot and floral grouping into the interior space; and
securing the floral sleeve about the pot by disposing a securing element about the floral sleeve thereby forming a plurality of overlapping folds in the sidewall of the body of the floral sleeve, the overlapping folds restrained in an overlapping condition by the securing element.

2. The method of claim 1 wherein in the step of providing a floral sleeve, the floral sleeve comprises a support extension for supporting the floral sleeve from a support device, the support extension extending from a top end of the back panel and detachable via a detaching element in the back panel.

3. The method of claim 1 wherein in the step of providing a floral sleeve, the floral sleeve comprises a support extension for supporting the floral sleeve from a support device, the support extension comprising a back panel extension extending from a top end of the back panel and a front panel extension extending from a top end of the front panel and detachable via a back panel detaching element in the back panel and a front panel detaching element in the front panel.

4. The method of claim 1 wherein in the step of providing a floral sleeve, the floral sleeve further comprises a tubular upper portion attached to a portion of the sidewall of the body of the floral sleeve and extending beyond the top side of the body of the floral sleeve.

5. The method of claim 4 wherein in the step of providing a floral sleeve, the tubular upper portion of the floral sleeve is attached to an inner surface of the front panel and to an inner surface of the back panel.

6. The method of claim 4 wherein in the step of providing a floral sleeve, the tubular upper portion of the floral sleeve is attached to an outer surface of the front panel and to an outer surface of the back panel.

7. The method of claim 4 wherein in the step of providing a floral sleeve, the tubular upper portion of the floral sleeve is sized to surround and enclose the floral grouping disposed within the pot when the pot and floral grouping are disposed within the interior space of the body of the floral sleeve.

8. The method of claim 1 wherein in the step of providing a floral sleeve, the floral sleeve is provided from a pad comprising a plurality of floral sleeves.

9. A plant package formed by the method of claim 1.

10. A method of wrapping a pot having a floral grouping disposed therein, comprising:
providing a floral sleeve comprising a body having a sidewall comprising a front panel and a back panel, the body initially having a flattened condition and the body, when in the flattened condition, having a hexagonal shape comprising a lower left side, a bottom side, a lower right side, an upper right side, a top side, and an upper left side, and wherein the lower left side, the bottom side, and the lower right side are closed and the upper right side, the top side, and the upper left side are open, and the body having an interior space when opened to an opened condition, the interior space sized to at least partially contain a pot; and
a tubular upper portion attached to a portion of the sidewall of the floral sleeve and extending beyond the top side of the body of the floral sleeve;
opening the floral sleeve to expose the interior space and disposing the pot and floral grouping into the interior space; and
securing the floral sleeve about the pot by disposing a securing element about the floral sleeve thereby forming a plurality of overlapping folds in the sidewall of the body of the floral sleeve, the overlapping folds restrained in an overlapping condition by the securing element.

11. The method of claim 10 wherein in the step of providing a floral sleeve, the tubular upper portion of the floral sleeve is attached to an inner surface of the front panel and to an inner surface of the back panel.

12. The method of claim 10 wherein in the step of providing a floral sleeve, the tubular upper portion of the floral sleeve is attached to an outer surface of the front panel and to an outer surface of the back panel.

13. The method of claim 10 wherein in the step of providing a floral sleeve, the tubular upper portion of the floral sleeve is sized to surround and enclose the floral grouping disposed within the pot when the pot and floral grouping are disposed within the interior space of the body of the floral sleeve.

14. The method of claim 10 wherein in the step of providing a floral sleeve, the floral sleeve is provided from a pad comprising a plurality of floral sleeves.

15. A plant package formed by the method of claim 10.
